(19) United States
(12) Patent Application Publication
(10) Pub. No.: US 2005/0062608 A1
(43) Pub. Date: Mar. 24, 2005

(54) Anti-theft device for items having portions that can be surrounded by straps or the like

(76) Inventor: Emilio Costa, Valdagno (IT)

Correspondence Address: Modiano & Associate, Via Meravigli 6, Milano, 20123, IT

(21) Appl. No.: 10/495,571

(22) PCT Filed: Oct. 28, 2002
(86) PCT No.: PCT/EP02/12028

(30) Foreign Application Priority Data
Nov. 27, 2001 (IT) PD2001U000111

(51) Int. Cl. G08B 13/14

(52) U.S. Cl. 340/572.9

(57) ABSTRACT

An anti-theft device for items having portions that can be surrounded by straps, comprising a strap, a container that contains an excitable signaling component and an engagement element in which one end of the strap can be inserted and locked, the strap incorporating at least partially a metallic insert.

### BACKGROUND OF THE INVENTION

As is known, anti-theft devices provided with a passive electronic component suitable to be detected if immersed in an electromagnetic field, normally generated in the presence of a guided exit of a shop or establishment in which the anti-theft devices are used, are currently increasingly widespread.

These devices are rigidly coupled to the item to be protected against theft and are then separated from it by breaking or removal by means of special equipment, usually when the item is regularly purchased.

Italian Patent 1.300.142 filed Jan. 13, 1998, discloses devices which comprise a strap that is suitable to close in a noose-like fashion on a portion of the item to be protected against theft.

The strap has a container for a component that is excitable and therefore detectable in the presence of electromagnetic fields.

From the container of the excitable component, the strap extends with two portions: a first one that bears a box-like expansion provided with a through hole, and a second one that is rack-shaped, with teeth having a triangular cross-section.

An elastic tab, shaped complementarily to the rack of the second portion, is provided inside the box-like expansion.

Once the second portion of the strap has been inserted in the box-like expansion of the first portion, the rack-like portion couples irreversibly to the tab, stably fixing the container that accommodates the excitable component to the object to which it is applied.

Although these devices have by now been commercially available for a few years and are appreciated thanks to the positive effects obtained by using them, they have been found to suffer drawbacks, an important one arising from the production of the strap by molding plastic material; since the strap has to be flexible, it is formed with a thickness that makes it vulnerable to cutting with ordinary cutting implements and therefore allows ill-intentioned individuals to separate the excitable component from the item to be protected.

### SUMMARY OF THE INVENTION

The aim of the present invention is to provide an anti-theft device for items that have portions that can be surrounded by straps or the like, which can be applied to said objects and gives them adequate protection against shoplifting.

Within this aim, an object of the present invention is to provide a device that is easy to apply and just as easy to separate by means of dedicated equipment.

Another object of the present invention is to provide a device that has extremely low costs, is particularly safe from the point of view of functionality, and is competitive in terms of purchase and operating costs with respect to alternative anti-theft methods.

A further object of the present invention is to provide an anti-theft device that can be applied and removed even by personnel lacking particular technical skill.

A still further object of the present invention is to provide an anti-theft device that can be manufactured with known technologies and facilities.

This aim and these and others objects that will become better apparent hereinafter are achieved by an anti-theft device for items having portions that can be surrounded by straps or the like, comprising a strap, a container that contains an excitable signaling component and an engagement means in which one end of the strap can be inserted and locked, characterized in that said strap incorporates at least partially a metallic insert.

### BRIEF DESCRIPTION OF THE DRAWINGS

Further characteristics and advantages of the present invention will become better apparent from the description of an embodiment thereof, illustrated only by way of non-limitative example in the accompanying drawings, wherein:

FIG. 1 is an exploded perspective view of a device according to the invention;

FIG. 2 is a perspective view of the device of FIG. 1, applied to the neck of a bottle;

FIG. 3 is a top view of the device of FIG. 1;

FIG. 4 is a sectional view of the device, taken along the line IV-IV of FIG. 3.

### DESCRIPTION OF THE PREFERRED EMBODIMENTS

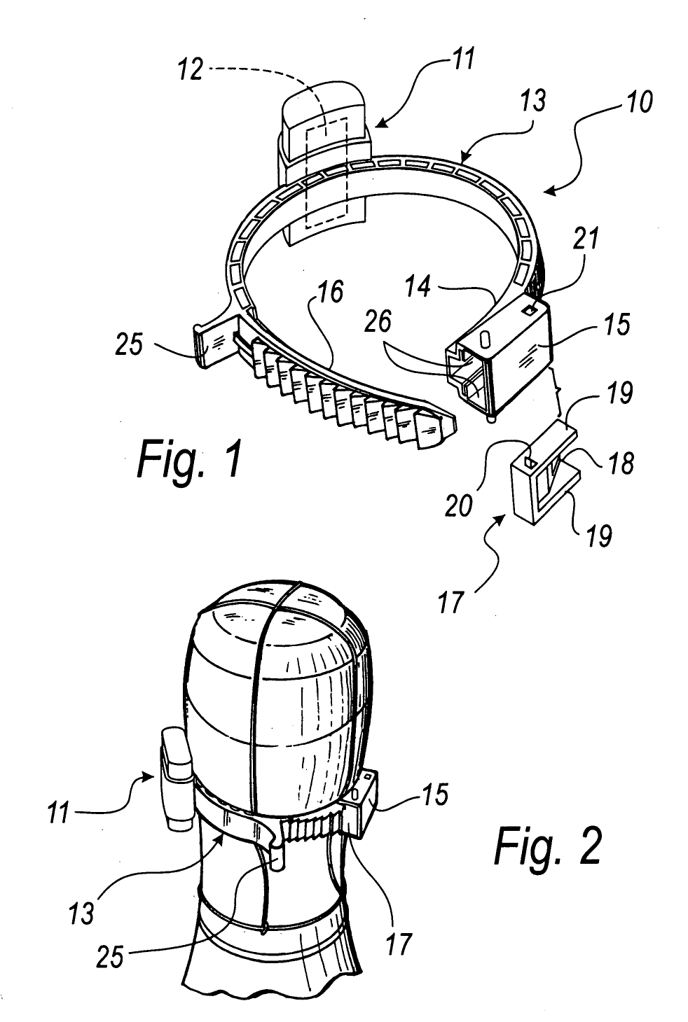

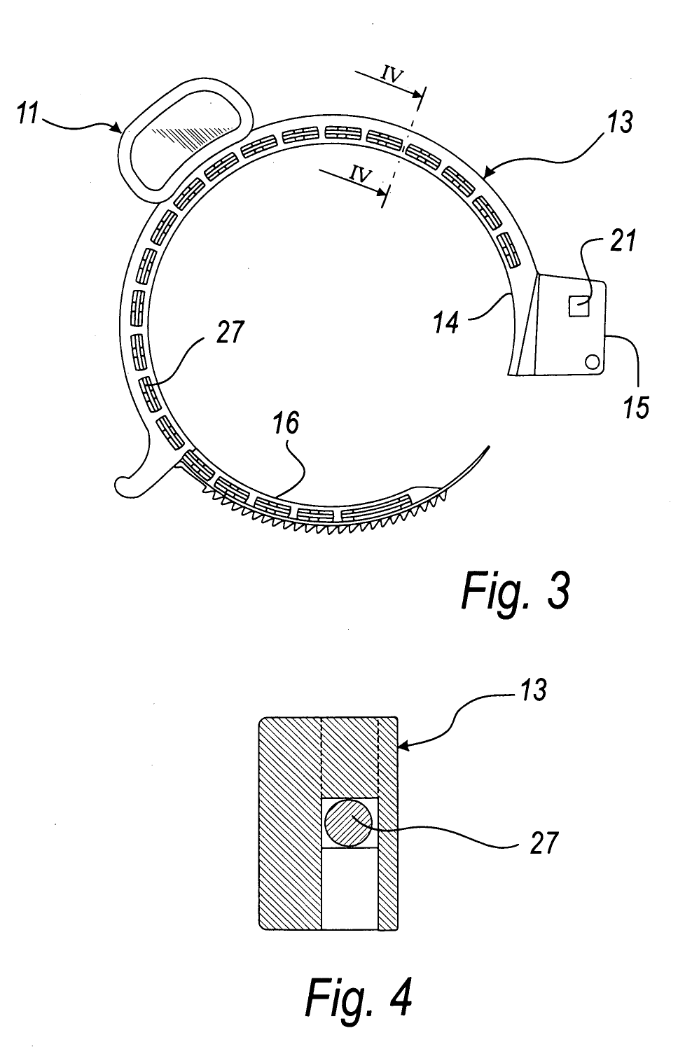

With reference to FIGS. 1 to 4, an anti-theft device for items provided with portions that can be surrounded, according to the invention, is generally designated by the reference numeral 10.

The device 10 comprises a container 11, which contains an excitable signaling device 12 that is monolithic with a strap 13, a first end 14 of which is shaped so as to form a hollow or box-like expanded portion 15 that is suitable to provide part of the closure of the device 10.

A second end 16 of the strap 13 is rack-shaped, with teeth having a triangular cross-section, and is suitable for insertion and coupling within the hollow expanded portion 15.

The device 10 comprises, in this embodiment, a closure element 17 having a central tongue 18 that is monolithic with respect to mutually opposite elastic wings 19, each of which has, at its end, a corresponding engagement tooth 20 that is directed outward and is inserted stably, on assembly, within a corresponding first through hole 21 formed at the corresponding wall of the hollow expanded portion 15.

The element 17 also has, at the tongue 18, a saw-tooth portion, not shown in the figures, which is suitable to mate with the rack-like shape of the second end 16 of the strap 13.

In this embodiment, the strap 13 also has an external anatomically contoured protrusion 25 that is available to the action of the user in order to facilitate the insertion of the second end 16 in the hollow expanded portion 15.

Furthermore, the hollow expanded portion 15 has an internal surface that is shaped so as to form two mutually opposite slots 26 for the guided insertion of the second end 16.

According to the invention, the strap 13 at least partially incorporates a metallic insert 27, which is inserted for example inside it or is embedded in the plastic material that is overmolded thereon.

The metallic insert 27 can be conveniently made of spring steel, both in laminar form and in wire form, such material being particularly strong yet flexible so as to allow in any case a noose-like closure around the item to be protected.

In order to disengage the parts one another, an apparatus such as the one disclosed in above cited Italian Patent 1.300.142 is used.

The apparatus allows recovery and reuse of the device 10.

It has been found that the present invention has achieved the intended aim and objects.

An anti-theft device for items having portions that can be surrounded has been provided which can be applied to such items, giving them adequate protection against theft by not being vulnerable to cutting.

The device is easy to apply and equally easy to separate by means of dedicated devices, and has extremely low costs.

Moreover, the device can be applied and removed even by personnel lacking particular technical skill.

The materials, so long as they are compatible with the contingent use, as well as the dimensions, may be any according to requirements.

The disclosures in Italian Utility Model Application No PD2001U000111 from which this application claims priority are incorporated herein by reference.

1-5. (cancelled).

6. An anti-theft device for items having portions that can be surrounded by straps, comprising a strap, a container that contains an excitable signaling component and an engagement means in which one end of the strap can be inserted and locked, wherein said strap incorporates at least partially a metallic insert.

7. The device of claim 6, wherein said metallic insert is inserted in said strap.

8. The device of claim 6, wherein said metallic insert is embedded in plastic material that is overmolded thereon.

9. The device of claim 6, wherein said metallic insert is formed by a spring steel lamina.

10. The device of claim 6, wherein said metallic insert is formed by spring steel wire.
